(19) United States
(12) Patent Application Publication
(10) Pub. No.: US 2014/0237344 A1
(43) Pub. Date: Aug. 21, 2014

(54) CONTRIBUTION DISPLAY SYSTEM, CONTRIBUTION DISPLAY METHOD, AND CONTRIBUTION DISPLAY PROGRAMME

(71) Applicant: Rakuten, Inc., Shinagawa-ku, Tokyo (JP)

(72) Inventors: Yusuke Murata, Shinagawa-ku (JP); Kenjiro Numazu, Shinagawa-ku (JP); Ruka Sakurai, Shinagawa-ku (JP)

(21) Appl. No.: 14/241,122

(22) PCT Filed: Dec. 25, 2012
(86) PCT No.: PCT/JP2012/083490

§ 371 Date: Feb. 26, 2014

(30) Foreign Application Priority Data
Jun. 29, 2012 (JP) 2012-14756

(51) Int. Cl. G06F 17/24; G06F 3/0483

(52) U.S. Cl. CPC G06F 17/241; G06F 3/0483
USPC 715/230

(57) ABSTRACT

To provide a post display system, a post display method and a post display program capable of avoiding giving away the content even when a spoiler is posted, a reading terminal (1) functions as a post display system for displaying posted information posted for an electronic book and includes a terminal page management unit (12) and a display restriction unit (14). The terminal page management unit (12) specifies an unread part of the electronic book not read by a user who reads the posted information. The display restriction unit (14) performs control to impose display restrictions on posted information associated with the unread part among posted information associated with any part of the electronic book. An unread part not read by a user is thereby specified, and display restrictions are imposed on posted information associated with the unread part among posted information associated with any part of the electronic book.

### TECHNICAL FIELD

The present invention relates to a post display system, a post display method, and a post display program.

### BACKGROUND ART

A device that displays the content of an electronic book such as a comic book together with comments from readers on panels or speech bubbles of the comic has been proposed. For example, the information display device disclosed in Patent Literature 1 displays that panels of the comic can be flipped and, when a panel is flipped, displays comments under the panel.

### CITATION LIST

### Patent Literature

PTL 1: Japanese Unexamined Patent Application Publication No. 2012-43078

### SUMMARY OF INVENTION

### Technical Problem

In some cases, a collection of comments from readers is displayed separately from the pages of a book. In such a case, there is a possibility that the displayed comments include a comment on a part not yet read which reveals the ending or plot if it is read at this point in time (a so-called “spoiler”). This significantly diminishes a reader's interest, causing a decrease in user-friendliness for readers.

In view of the foregoing, an object of the present invention is to provide a post display system, a post display method, and a post display program capable of avoiding giving away the content even when a spoiler is posted.

### Solution to Problem

A post display system according to one embodiment of the invention is a post display system for displaying posted information posted for an electronic book, including a specifying means configured to specify an unread part of the electronic book not read by a user who reads the posted information, and a control means configured to perform control to impose display restrictions on posted information associated with the unread part among posted information associated with any part of the electronic book.

In the post display system according to one embodiment of the invention, an unread part of the electronic book that is not yet read by a user who reads posted information is specified, and control is performed to impose display restrictions on posted information associated with the unread part among posted information associated with any part of the electronic book. The posted information associated with the unread part for a user is likely to give away the content if read. According to this embodiment, display restrictions are imposed on the posted information associated with the unread part. It is thereby possible to avoid giving away the content for a user who has not read a part where there is a post containing a spoiler. Further, because unnecessary information is not displayed, the load on display processing can be reduced. Furthermore, because unnecessary information is not displayed, the waste of a display area can be saved.

In the post display system according to another embodiment, at timing when a set time has elapsed from when a page turning operation by the user is accepted, the specifying means may exclude a page displayed in response to the page turning operation from the unread part, and at timing when a set time has elapsed from when a page turning operation by the user is accepted, the control means may perform control to cancel display restrictions on the posted information associated with the page displayed in response to the page turning operation.

In this embodiment, at timing when a set time has elapsed from when a page turning operation by the user is accepted, a page that is displayed in response to the page turning operation is excluded from the unread part. Further, at timing when a set time has elapsed from when a page turning operation by the user is accepted, display restrictions are cancelled on the posted information associated with the page displayed in response to the page turning operation. Thus, at the moment when the user turns a page, the user has not yet read the page and therefore the posted information is not displayed, and, when the set time has elapsed and it is estimated that the user has read the page, the posted information is displayed.

In the post display system according to another embodiment, the set time may be set based on a past reading time and the number of pages displayed during the reading time.

In this embodiment, the set time is set based on the past reading time and the number of pages displayed during the reading time. It is thereby possible to predict the timing when a user finishes reading the page opened in accordance with the reading speed of each user and determine the timing to display the posted information.

In the post display system according to another embodiment, the posted information associated with any part of the electronic book may contain flag information capable of enabling setting to make display restrictions unnecessary, and the control means may not perform control to impose display restrictions on posted information to which the setting is applied by the flag information among the posted information associated with the unread part.

In this embodiment, the posted information contains flag information capable of enabling setting to make display restrictions unnecessary, and display restrictions are not imposed on posted information to which the setting is applied by the flag information among the posted information associated with the unread part. Thus, when the setting to make display restrictions unnecessary is applied, display restrictions are not imposed even when the posted information is associated with the unread part. For example, posted information that causes no problem when displayed can be displayed by setting the flag. Accordingly, a user can see the posted information that causes no problem when displayed.

In the post display system according to another embodiment, the control means can accept inappropriateness information indicating that the setting is inappropriate for the posted information to which the setting is applied by the flag information, and the control means may cancel the setting when accepting a predetermined number or more of inappropriateness information.

In this embodiment, inappropriateness information indicating that the setting is inappropriate for the posted information to which the setting is applied by the flag information can be accepted, and when a predetermined number or more of inappropriateness information is accepted, the setting to make display restrictions unnecessary is cancelled. Thus, when a predetermined number or more of general users consider the subject posted information as a spoiler and transmit the inappropriateness information, for example, the setting is cancelled and display restrictions are imposed. As a result, it is possible to avoid diminishing a user's interest and prevent a decrease in user-friendliness.

In the post display system according to another embodiment, the post display system may further include a storage means configured to store genre information indicating a genre to which the electronic book belongs, and when the genre information stored in the storage means indicates a specific genre, the control means may not perform control to impose display restrictions on the posted information.

In this embodiment, when the genre information indicates a specific genre, display restrictions are not imposed on the posted information posted for the electronic book. The posted information in an electronic book of a specific genre that has nothing to do with the ending or plot is thereby displayed without display restrictions. It is thereby possible to let a user read all posted information for an electronic book of a specific genre without any disadvantages to the user.

In the post display system according to another embodiment, the specifying means may specify a read part already read by the user, and the control means may perform control to display posted information associated with a part having been read after reading of a predetermined number of times before, among the read part specified by the specifying means, with an increased priority of display.

In this embodiment, a read part already read by the user is specified, and posted information associated with a part having been read after reading of a predetermined number of times before, among the read part specified by the specifying means, is displayed with an increased priority of display. A user can thereby preferentially see the posted information associated with the part having been read.

In the post display system according to another embodiment, the specifying means may specify a read part already read by the user, and the control means may perform control to display posted information associated with a part between a read part displayed again at start of previous reading and a read part displayed again at last of the reading, among the read part specified by the specifying means, with an increased priority of display.

In this embodiment, a read part already read by the user is specified, and posted information associated with a part between a read part displayed again at start of previous reading and a read part displayed again at last of the reading, among the read part specified by the specifying means, is displayed with an increased priority of display. The part between the read part displayed again at the start of previous reading in the reading terminal and the read part displayed again at the last of the reading is displayed again even through they are the read part. Therefore, it is considered that the user's interest in this part is strong. In this case, the posted information associated with the part in which the user is likely to have a strong interest can be preferentially seen by the user.

In the post display system according to another embodiment, the specifying means may specify a read part already read by the user, and the control means may perform control to display posted information associated with a read part having been displayed a predetermined number of times or more, among the read part specified by the specifying means, with an increased priority of display.

In this embodiment, a read part already read by the user is specified, and posted information associated with a read part having been displayed a predetermined number of times or more, among the read part specified by the specifying means, is displayed with an increased priority of display. Therefore, the posted information associated with the part in which the user is likely to be interested because it has been displayed a predetermined number of times or more can be seen by the user.

In the post display system according to another embodiment, the post display system may further include a determination means configured to determine whether purchase processing is done for the electronic book by a user of a reading terminal capable of displaying the electronic book, and when the determination means determines that the purchase processing is not done for the electronic book, the control means may not perform control to impose display restrictions on posted information associated with a predetermined specified part of the electronic book.

In this embodiment, when the determination means determines that the purchase processing is not done for the electronic book, control to impose display restrictions on posted information associated with a predetermined specified part of the electronic book is not performed. By specifying the part for which display restrictions of posted information are not necessary in order to attract a user's interest as specified pages, the posted information associated with the specified part can be displayed on the reading terminal without display restrictions. It is thereby possible to make a user have an interest in the electronic book for which purchase processing is not done.

In the post display system according to another embodiment, the control means may perform control to display the number of posted information associated with the unread part among the posted information associated with any part of the electronic book.

In this embodiment, the number of posted information associated with the unread part among the posted information associated with any part of the electronic book is displayed. A user can thereby recognize the number of posted information associated with the unread part.

A post display method according to one embodiment of the invention is a post display method performed by a post display system for displaying posted information posted for an electronic book, the method including a specifying step in which the post display system specifies an unread part of the electronic book not read by a user who reads the posted information, and a control step in which the post display system performs control to impose display restrictions on posted information associated with the unread part among posted information associated with any part of the electronic book.

In the post display method according to one embodiment of the invention, an unread part of the electronic book that is not yet read by a user who reads posted information is specified, and control is performed to impose display restrictions on posted information associated with the unread part among posted information associated with any part of the electronic book. The posted information associated with the unread part for a user is likely to give away the content if read. According to this embodiment, display restrictions are imposed on the posted information associated with the unread part. It is thereby possible to avoid giving away the content for a user who has not read a part where there is a post containing a spoiler. Further, because unnecessary information is not displayed, the load on display processing can be reduced. Furthermore, because unnecessary information is not displayed, the waste of a display area can be saved.

A post display program according to one embodiment of the invention is a post display program for displaying posted information posted for an electronic book, the program causing a computer to implement a function of a specifying means to specify an unread part of the electronic book not read by a user who reads the posted information, and a function of a control means to perform control to impose display restrictions on posted information associated with the unread part among posted information associated with any part of the electronic book.

In the post display program according to one embodiment of the invention, an unread part of the electronic book that is not yet read by a user who reads posted information is specified, and control is performed to impose display restrictions on posted information associated with the unread part among posted information associated with any part of the electronic book. The posted information associated with the unread part for a user is likely to give away the content if read. According to this embodiment, display restrictions are imposed on the posted information associated with the unread part. It is thereby possible to avoid giving away the content for a user who has not read a part where there is a post containing a spoiler. Further, because unnecessary information is not displayed, the load on display processing can be reduced. Furthermore, because unnecessary information is not displayed, the waste of a display area can be saved.

A computer-readable recording medium according to one embodiment of the invention is a computer-readable recording medium storing a post display program for displaying posted information posted for an electronic book, the program causing a computer to implement a function of a specifying means to specify an unread part of the electronic book not read by a user who reads the posted information, and a function of a control means to perform control to impose display restrictions on posted information associated with the unread part among posted information associated with any part of the electronic book.

In the computer-readable recording medium according to one embodiment of the invention, an unread part of the electronic book that is not yet read by a user who reads posted information is specified, and control is performed to impose display restrictions on posted information associated with the unread part among posted information associated with any part of the electronic book. The posted information associated with the unread part for a user is likely to give away the content if read. According to this embodiment, display restrictions are imposed on the posted information associated with the unread part. It is thereby possible to avoid giving away the content for a user who has not read a part where there is a post containing a spoiler. Further, because unnecessary information is not displayed, the load on display processing can be reduced. Furthermore, because unnecessary information is not displayed, the waste of a display area can be saved.

### Advantageous Effects of Invention

According to the present invention, it is possible to provide a post display system, a post display method and a post display program capable of avoiding giving away the content even when a spoiler is posted.

### BRIEF DESCRIPTION OF DRAWINGS

FIG. 1 is a functional diagram illustrating the functional configuration of an information processing system 100.

FIG. 2 is a physical diagram illustrating the physical configuration of a reading terminal 1.

FIG. 3 is a physical diagram illustrating the physical configuration of a book server 2.

FIG. 4 is a page management schematic diagram showing an example of page management by a terminal page management unit.

FIG. 5 is a display example on a display in the case of FIG. 4.

FIG. 6 is a page management schematic diagram showing an example of page management by a terminal page management unit.

FIG. 7 is a page management schematic diagram showing an example of page management by a terminal page management unit.

FIG. 8 is a flowchart illustrating the flow of a sequence of a process performed by the reading terminal 1.

FIG. 9 is a module diagram illustrating the module configuration of a post display program P.

FIG. 10 is a schematic diagram illustrating an alternative example of displayed content on a display of the reading terminal 1.

FIG. 11 is a schematic diagram illustrating an alternative example of displayed content on a display of the reading terminal 1.

### DESCRIPTION OF EMBODIMENTS

An embodiment of the present invention is described hereinafter in detail with reference to the appended drawings. Note that, in the description of the drawings, the same or equivalent elements are denoted by the same reference symbols, and the redundant explanation thereof is omitted.

### <1> Configuration of Post Display System

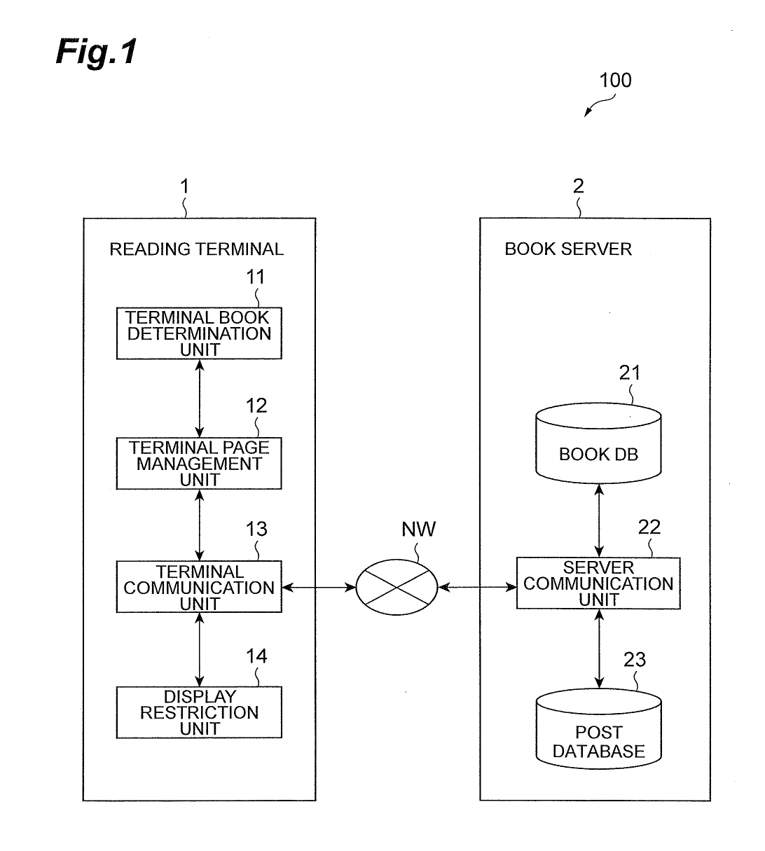

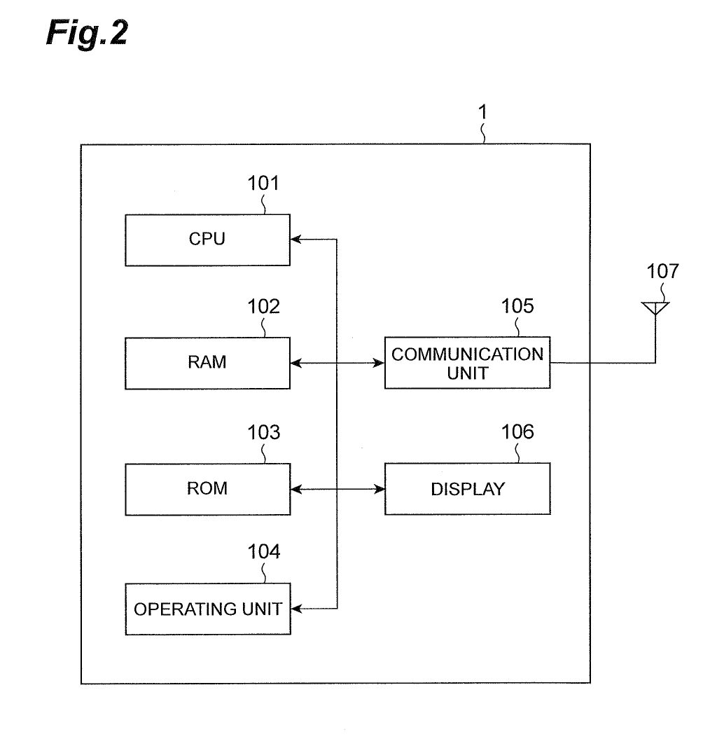

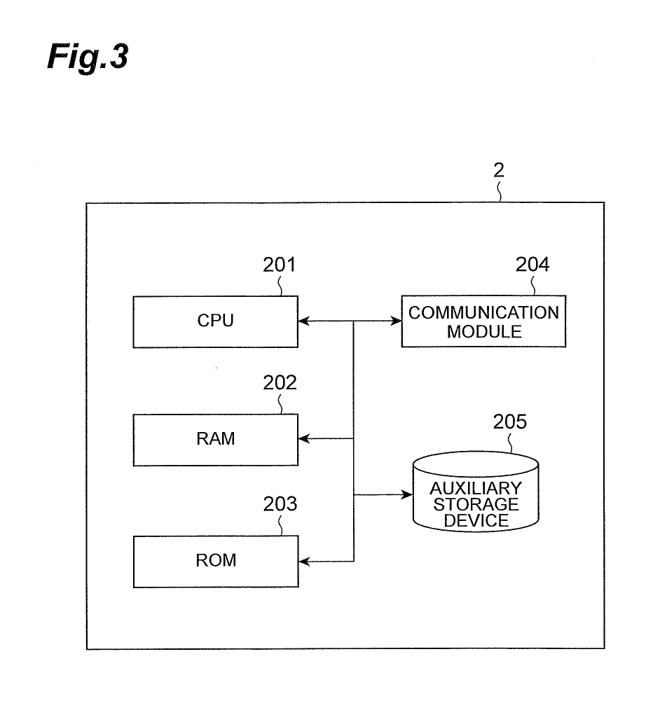

First, the configuration of a post display system according to the present invention is described hereinafter with reference to FIGS. 1 to 3. FIG. 1 is a functional diagram illustrating the functional configuration of an information processing system 100. The information processing system 100 includes a reading terminal 1 and a book server 2. The reading terminal 1 functions as a post display system according to the present invention and displays posted information posted for an electronic book. The posted information is a comment posted by a poster in association with any part of an electronic book. A poster can post the posted information in association with a chapter, page, sentence, line, word or the like of an electronic book. Information indicating a part that is associated with posted information by a poster is referred to as part information. The part information is added to posted information when a poster posts the posted information and transmitted from the terminal to the book server 2. The part information is information such as line B on page A to line D on page C, for example. FIG. 2 is a physical diagram illustrating the physical configuration of the reading terminal 1, and FIG. 3 is a physical diagram illustrating the physical configuration of the book server 2.

The reading terminal 1 shown in FIG. 1 is a device such as a smartphone, a mobile phone terminal or a personal computer capable of displaying an electronic book. After starting an application for viewing an electronic book and initiating display of the electronic book, the reading terminal 1 can accept a user operation to turn a page of the electronic book. In response to the user operation to turn a page, the reading terminal 1 displays the way the page is turned. Further, the reading terminal 1 can display posted information that is associated with any of a plurality of pages contained in the electronic book. The reading terminal 1 can communicate with the book server 2 through a communication network NW such as a radio base station or a wired communication network. The book server 2 is a device such as a server or a host computer that manages an electronic book displayed on the reading terminal 1. For example, the book server 2 manages whether the electronic book stored in the reading terminal 1 is the one purchased by a user of the reading terminal 1 or not.

The configuration of the reading terminal 1 is described next. As shown in FIG. 2, the reading terminal 1 is configured as a computer that includes hardware such as a CPU 101 (Central Processing Unit), a RAM 102 (Random Access Memory) and a ROM 103 (Read Only Memory) serving as main storage devices, an operating unit 104 for operating the reading terminal 1, a communication unit 105 for performing communication, a display 106 and an antenna 107 as principal physical components. Those components operate so that the functions of the reading terminal 1 are exerted as described below.

Further, as shown in FIG. 1, the reading terminal 1 includes a terminal book determination unit 11 (determination means), a terminal page management unit 12 (specifying means), a terminal communication unit 13, and a display restriction unit 14 (control means) as principal functional components. The reading terminal 1 stores data of all pages of an electronic book which has been purchased so that a user can view all the pages. Further, the reading terminal 1 stores data of trial pages of an electronic book which has not yet been purchased and for which a user has requested to read by trial so that the user can read some of the pages by trial.

The terminal book determination unit 11 is a determination processing unit that determines whether purchase processing is done for the electronic book stored in the reading terminal 1 by a user of the reading terminal 1. The terminal book determination unit 11 stores purchase determination flag information and, at the time of performing purchase processing in the reading terminal 1, the terminal book determination unit 11 updates the purchase determination flag information from “0” indicating that it has not been purchased to “1” indicating that it has been purchased and stores the flag information. Then, at the time of displaying the electronic book, the terminal book determination unit 11 determines whether purchase processing is done or not by referring to the purchase determination flag information.

The terminal page management unit 12 is a processing unit that specifies an unread part (unread pages) that has not yet been read by a user. First, the terminal page management unit 12 specifies pages on which display processing has been performed in the reading terminal 1 among a plurality of pages contained in an electronic book and stores the pages as read pages that have already been read by a user of the reading terminal 1. In other words, the displayed pages are stored as a read part (read pages). Then, the terminal page management unit 12 specifies a part other than the read part as an unread part. Note that, in the reading terminal 1, processing of displaying the following (next) page is performed in response to a user operation to turn a page.

The terminal communication unit 13 is a communication processing unit that transmits and receives various signals (information) to and from the book server 2. The terminal communication unit 13 can acquire posted information from the book server 2 in response to a user operation. The posted information includes a poster ID that uniquely identifies a poster. Note that a poster may select a chapter or word of an electronic book and post information in association with the selected part. In this case, the posted information is stored in association with a page where the first part of the chapter or word selected by the poster is shown.

Note that the posted information acquired by the terminal communication unit 13 contains restrictions necessity flag information. The restrictions necessity flag information indicates whether restrictions on display, which is described later, by the display restriction unit 14 are necessary or not. Thus, by using the restriction necessity flag information, it is possible to apply restrictions unnecessary setting to make display restrictions unnecessary. When a user who posts information determines that it is not a spoiler, the user can apply the restrictions unnecessary setting that makes display restrictions on the posted information unnecessary.

The display restriction unit 14 is a control unit that generates display information for displaying the posted information acquired by the terminal communication unit 13 on the reading terminal 1. The display restriction unit 14 performs control to display the posted information associated with read pages on the reading terminal 1 based on the generated display information. Further, the display restriction unit 14 generates display information to impose display restrictions in the reading terminal 1 on the posted information associated with unread pages (or the whole chapter including unread pages). The display restriction unit 14 may impose display restrictions on the posted information associated with unread pages by showing only information irrelevant to the content of the post, such as the number of posts, the position of posting or a poster, without displaying the content of the post. Further, the display restriction unit 14 may impose display restrictions by showing the characters representing the content of the post with a color or font that is not easily visible (difficult to see) to a user. When the proportion of the number of posted information on which display restrictions are imposed to the total number of posted information is a predetermined value or more, the display restriction unit 14 may display the total number of posted information.

Further, in the case where the terminal book determination unit 11 determines that purchase processing is not done for the electronic book, the display restriction unit 14 generates display information for displaying the posted information associated with trial pages (preview pages) of the non-purchased electronic book without performing control to impose display restrictions. The trial pages are predetermined specified pages in the electronic book.

Further, the display restriction unit 14 can generate display information for displaying the posted information which is associated with pages that have been read after reading of a predetermined number of times before, among the read pages, with an increased priority of display. The pages that have been read are pages between the last page of the read pages stored in the terminal page management unit 12 and the last page of the read pages in reading of a predetermined number of times before in the reading terminal 1. The display restriction unit 14 generates display information for displaying the posted information associated with the pages that have been read using the characters representing the content with a color or font that is easily visible to a user.

Further, the display restriction unit 14 can generate display information for displaying the posted information which is associated with reread pages in the reading terminal 1, among the read pages stored in the terminal page management unit 12, with an increased priority of display. The reread pages are pages that are displayed repeatedly between the read page displayed again at the start of the previous reading in the reading terminal 1 and the read page displayed again at the last of the reading. The display restriction unit 14 generates display information for displaying the posted information associated with the reread pages using the characters representing the content with a color or font that is easily visible to a user.

Further, the display restriction unit 14 can generate display information for displaying the posted information which is associated with read pages that have been displayed a predetermined number of times or more, among the read pages stored in the terminal page management unit 12, with an increased priority of display. The display restriction unit 14 generates display information for displaying the posted information associated with the read pages displayed a predetermined number of times or more using the characters representing the content with a color or font that is easily visible to a user.

Further, the display restriction unit 14 can generate display information for displaying the posted information which is associated with unread pages stored in the terminal page management unit 12 and to which the restrictions unnecessary setting is applied by the restrictions necessity flag information described above without performing control to impose display restrictions.

Further, in the case where the restrictions unnecessary setting is applied to posted information, the display restriction unit 14 does not impose display restrictions even when the posted information is associated with unread pages. Accordingly, the posted information which a poster has determined as not being a spoiler and thus made the restrictions unnecessary setting can be displayed.

Further, when genre information stored in a book database 21, which is described later, indicates a specific genre, the display restriction unit 14 generates display information for displaying all posted information without performing display restriction processing, which is described later. The genre information indicates a genre to which the electronic book stored in the reading terminal 1 belongs. The terminal page management unit 12 transmits a signal requesting transmission of genre information to the book server 2 and receives the genre information from the book server 2. The terminal page management unit 12 may store the genre information in association with the electronic book. Note that setting of the specific genre can be changed by a user operation on the reading terminal 1.

The configuration of the book server 2 is described hereinafter. As shown in FIG. 3, the book server 2 is configured as a computer that includes hardware such as a CPU 201, a RAM 202 and a ROM 203, a communication module 204 for performing communication, and an auxiliary storage device 205 such as a hard disk as principal physical components. Those components operate so that the functions of the book server 2 are exerted as described below.

Further, the book server 2 includes a book database 21 (storage means), a server communication unit 22 (control means), and a post database 23 (collection means).

The book database 21 is a database that stores genre information indicating a genre to which each of electronic books belongs. The book database 21 stores a book ID that uniquely identifies an electronic book and a genre ID that indicates a genre in association with each other.

The server communication unit 22 is a communication processing unit that transits and receives various signals (information) to and from the reading terminal 1. The server communication unit 22 can transmit posted information associated with any of a plurality of pages contained in an electronic book to the reading terminal 1. The server communication unit 22 receives a signal requesting transmission of posted information from the reading terminal 1 and then transmits the posted information

The post database 23 is a database that stores posted information associated with any of a plurality of pages contained in an electronic book. The post database 23 stores a page corresponding to posted information and the posted information in association with each other.

Further, inappropriateness information indicating that the restrictions unnecessary setting in posted information to which the restrictions unnecessary setting is applied by the restrictions necessity flag information described above is inappropriate can be reflected in the post database 23. The inappropriateness information can be received (accepted) by the server communication unit 22 from a communication terminal of a poster or the like. In the case where the server communication unit 22 receives a predetermined number or more of inappropriateness information, the setting to make display restrictions unnecessary is changed to the setting to make display restrictions necessary in the book server 2 (the restrictions unnecessary setting is cancelled). The inappropriateness information is used for the purpose that another poster modifies the setting of the posted information to which the setting that does not require display restrictions (because it contains no spoiler) has been applied by one poster to the setting that requires display restrictions (because it actually contains a spoiler).

### <2> Example of Page Management by Terminal Page Management Unit

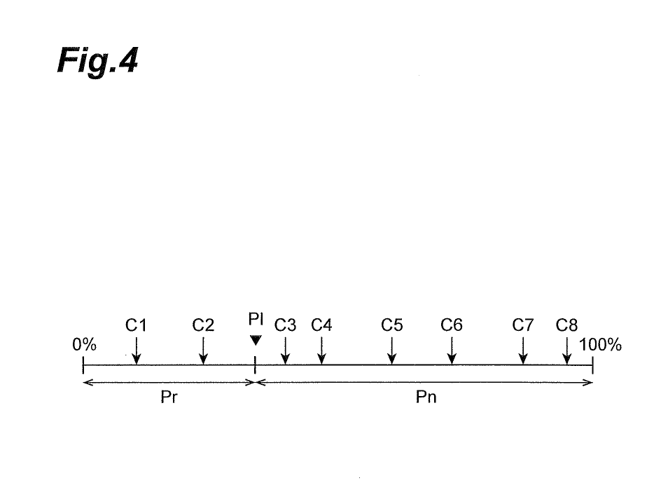

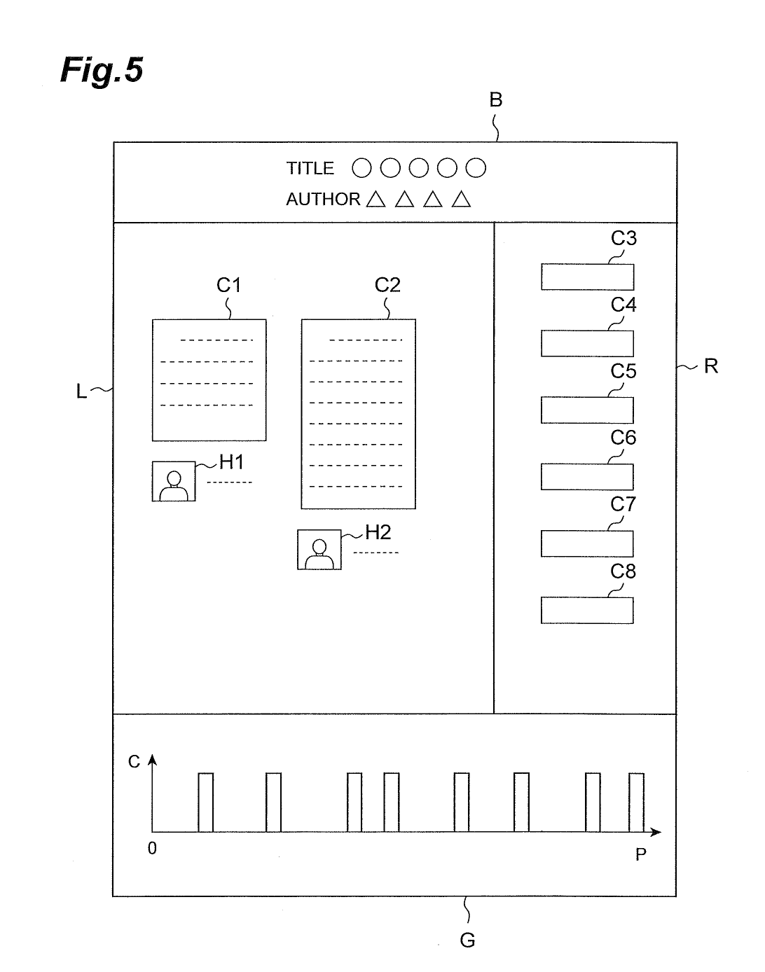

An example of page management by the terminal page management unit 12 is described hereinafter with reference to FIGS. 4 to 7. Each of FIGS. 4, 6 and 7 is a page management schematic diagram showing an example of page management by the terminal page management unit, and FIG. 5 is a display example on a display in the case of FIG. 4.

As shown in FIG. 4, the terminal page management unit 12 specifies a page P1 on which display processing has been performed in the reading terminal 1 among a plurality of pages contained in an electronic book. The terminal page management unit 12 specifies the pages on which display processing has been performed in the reading terminal 1 (example: page 1 to page 20) as read pages. Note that the terminal page management unit 12 may specify a last read page on which display processing was performed last time and then specifies pages from the first page to the last read page as read pages. Then, the terminal page management unit 12 stores pages from the position of 0% (example: page 1) to the page P1 as read pages Pr. After that, the terminal page management unit 12 specifies the pages on which display processing has not been performed in the reading terminal 1 (pages from the page P1 to the position of 100%) and stores them as unread pages Pn (pages other than the read pages).

Then, the terminal communication unit 13 acquires posted information associated with each of the read pages Pr and the unread pages Pn. The display restriction unit 14 then displays posted information C1 and C2 associated with the read pages Pr among the posted information acquired by the terminal communication unit 13 on the reading terminal 1. Further, the display restriction unit 14 restricts display of posted information C3 to C8 associated with the unread pages Pn on the reading terminal 1.

As a result, the displayed content on a display of the reading terminal 1 is as shown in FIG. 5. The display on the reading terminal 1 is segmented into roughly four (upper, lower, left and right) parts. In the upper part B, information (example: title and author) about an electronic book for which posted information is displayed is displayed. In the left part L, the posted information C1 and C2 associated with the read pages Pr is displayed. The posted information C1 and C2 is displayed respectively together with poster information H1 and H2 about posters based on the above-described poster ID.

Further, in the right part R, the posted information C3 to C8 associated with the unread pages Pn are displayed as icons without displaying their content. Note that, when each of the posted information C3 to C8 is selected by touch or the like, a dialogue that asks “it contains a spoiler; do you really want to see it?” is displayed. When selection by touch or the like is made to enable display, the content of each of the posted information C3 to C8 is displayed. In the lower part G, a graph showing the position and the number of posted information is displayed. The horizontal axis of the graph indicates a position (page P) where there is posted information in an electronic book, and the vertical axis indicates the number C of posted information.

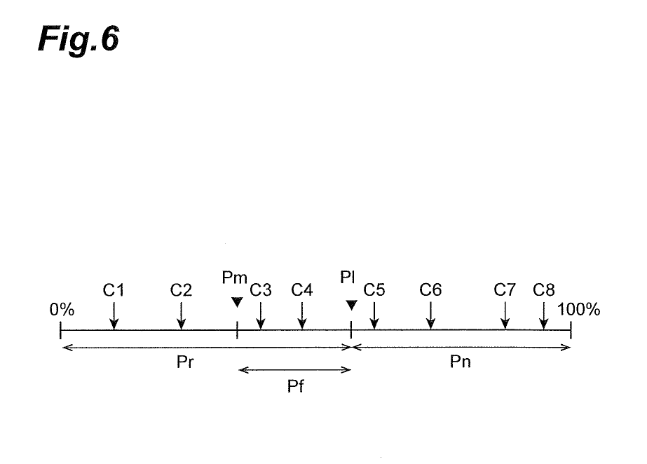

The case where an application for reading an electronic book is launched a predetermined number of times (for example, once) in the reading terminal 1 after the state of FIG. 4 and the state has changed to the one shown in FIG. 6 is described hereinbelow. The terminal page management unit 12 specifies pages Pf that have been read during a predetermined number of times of reading in the reading terminal 1, among the read pages Pr. The pages Pf having been read are pages between the last page P1 and the last page Pm. The last page P1 is the last page of the read pages Pr stored in the terminal page management unit 12. The last page Pm is the last page of the read pages in reading of a predetermined number of times before in the reading terminal 1.

Then, the display restriction unit 14 displays the posted information C3 and C4 associated with the above-described pages Pf having been read, among the read pages Pr stored in the terminal page management unit 12, with an increased priority of display. The display restriction unit 14 displays the posted information C3 and C4 associated with the pages Pf having been read using the characters representing the content with a color or font that is easily visible to a user. Note that the display restriction unit 14 may display the posted information C3 and C4 in the upper part than the other posted information.

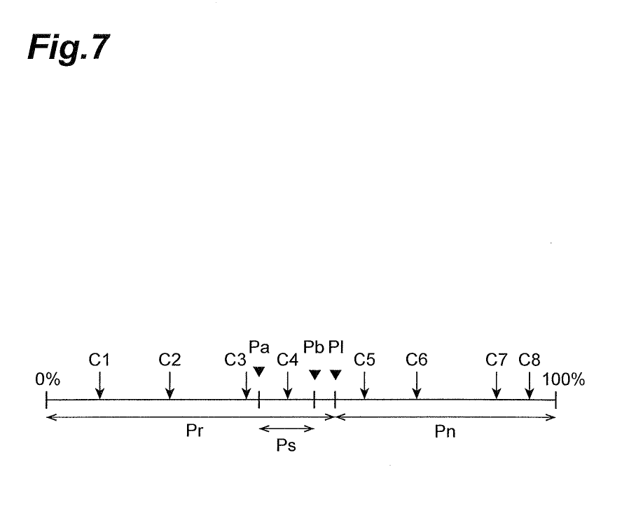

Further, the case where the state has changed from the state of FIG. 6 to the state shown in FIG. 7 after the electronic book was read once in the reading terminal 1 is described hereinbelow. The terminal page management unit 12 specifies reread pages Ps, among the read pages Pr, in the reading terminal 1. The reread pages Ps are repeatedly displayed pages that have been displayed a plurality of times. Note that the reread pages Ps may be repeatedly displayed pages between a read page Pa and a read page Pb. In this case, the read page Pa is the read page displayed again at the start of the previous reading in the reading terminal 1, and the read page Pb is the read page displayed again at the last of the reading.

Then, the display restriction unit 14 displays the posted information C4 associated with the above-described reread pages Ps, among the read pages Pr stored in the terminal page management unit 12, with an increased priority of display. The display restriction unit 14 displays the posted information C4 associated with the reread pages Ps using the characters representing the content with a color or font that is easily visible to a user. Note that the display restriction unit 14 may display the posted information C3 and C4 in the upper part than the other posted information.

### <3> Sequence of Process Performed by Reading Terminal 1

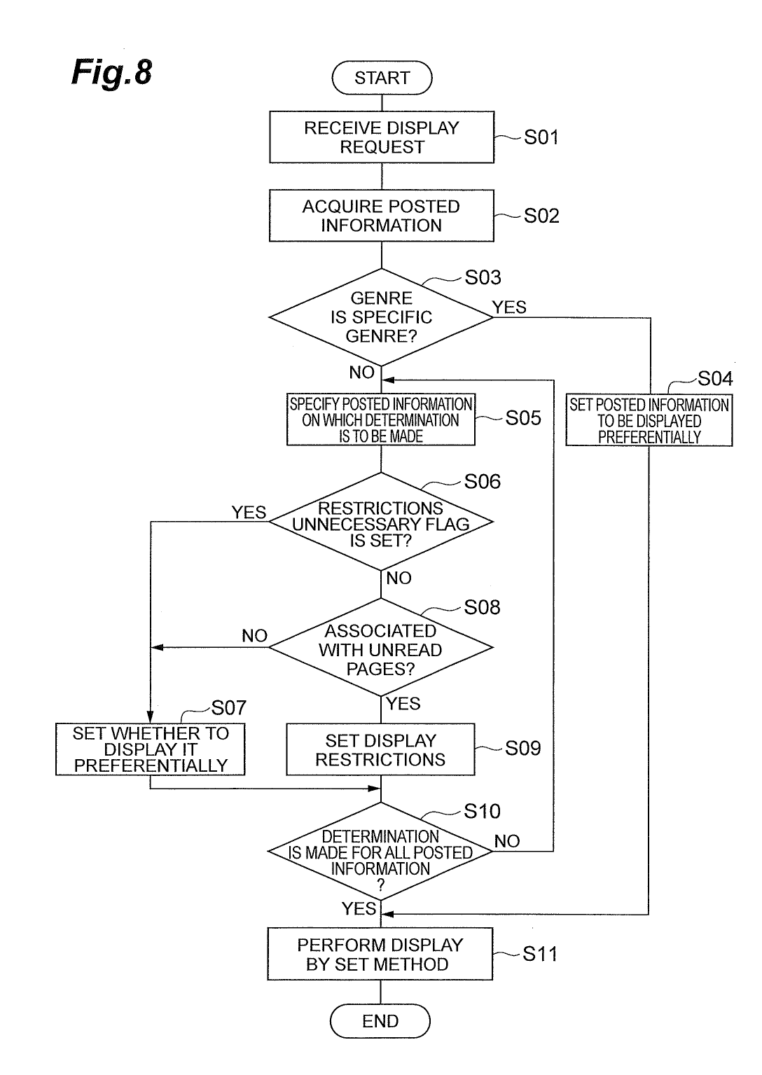

An example of a sequence of a process (post display method) performed by the reading terminal 1 is described hereinafter with reference to FIG. 8. FIG. 8 is a flowchart illustrating the flow of a sequence of a process performed by the reading terminal 1. This process is a process in the reading terminal 1 in the case where posted information posted for an electronic book is displayed together outside the page where the electronic book is displayed as shown in FIG. 5. Unread pages of the electronic book can be specified in advance regardless of whether purchase processing is done by a user of the reading terminal 1.

First, an operation to request display of posted information posted for read pages of the electronic book is performed by a user on the reading terminal 1. The reading terminal 1 thereby receives a request for display of posted information (Step S01). Then, the terminal page management unit 12 specifies read pages and unread pages (specifying step), and the terminal communication unit 13 transmits a signal requesting transmission of posted information to the book server 2. Then, the terminal communication unit 13 acquires posted information from the book server 2 (Step S02, post acquisition step).

Next, the terminal page management unit 12 transmits a signal requesting transmission of genre information to the book server 2 and receives genre information from the book server 2. The terminal page management unit 12 then determines whether the genre information indicates a specific genre or not (Step S03). When the genre information indicates a specific genre in Step S03, the display restriction unit 14 generates display information for displaying all posted information without performing display restriction processing on the posted information acquired in Step S02 (generation step). Then, the display restriction unit 14 sets the posted information to be displayed with an increased priority of display to the display information (Step S04), and the process proceeds to Step S11 described later. On the other hand, when the genre information does not indicate a specific genre in Step S03, the process proceeds to Step S05 described later.

In step S05, the display restriction unit 14 specifies posted information on which determination is not done and thus determination as to whether display restrictions should be imposed is to be made. Then, the display restriction unit 14 determines whether the restrictions necessity flag information contained in the posted information specified in Step S05 indicates the restrictions unnecessary setting or not (Step S06). When the flag information indicates the restrictions unnecessary setting in Step S06, the process proceeds to Step S07 described later. On the other hand, when the flag information does not indicate the restrictions unnecessary setting in Step S06, the process proceeds to Step S08 described later.

In step S07, the display restriction unit 14 generates display information that contains settings as to whether the posted information on which determination is to be made should be displayed with an increased priority of display, and the process proceeds to Step S10 described later (generation step).

In step S08, the display restriction unit 14 determines whether the posted information on which determination is to be made is associated with unread pages. When it is not associated with unread pages in Step S08, the process proceeds to Step S07 described above. On the other hand, when it is associated with unread pages in Step S08, the process proceeds to Step S09 described later.

In step S09, the display restriction unit 14 generates display information to impose display restrictions in the reading terminal 1 on the posted information associated with unread pages (control step). Then, the process proceeds to Step S10 described later.

In step S10, the display restriction unit 14 determines whether all posted information has become information to be determined whether display restrictions are imposed thereon or not. When there remains posted information that has not become information to be determined whether display restrictions are imposed thereon, the process proceeds to Step S05 described above. On the other hand, when all posted information have become information to be determined whether display restrictions are imposed thereon, the process proceeds to Step S11 described later.

In step S11, the display restriction unit 14 display the posted information associated with read pages on the display 106 of the reading terminal 1 based on the generated display information. As for the posted information associated with unread pages, because display information is generated to impose display restrictions in the reading terminal 1, display restrictions are imposed on the posted information associated with unread pages.

### <4> Module Configuration of Post Display Program

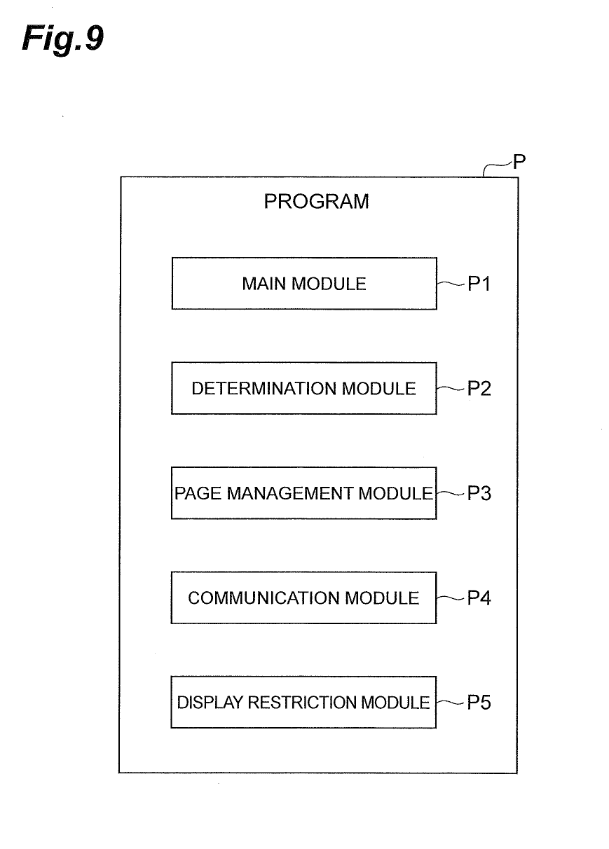

The module configuration of a post display program that causes a computer to function as the reading terminal 1 is described hereinafter with reference to FIG. 9. FIG. 9 is a module diagram illustrating the module configuration of a post display program P that causes a computer to function as the reading terminal 1.

As shown in FIG. 9, the post display program P includes a main module P1, a determination module P2, a page management module P3, a communication module P4 and a display restriction module P5.

The main module P1 is a part that exercises control over the function of executing processing of various information. The above-described functions of the reading terminal 1 are implemented by executing the main module P1.

Further, the functions implemented by executing the determination module P2, the page management module P3, the communication module P4 and the display restriction module P5 are equal to the functions of the terminal book determination unit 11, the terminal page management unit 12, the terminal communication unit 13 and the display restriction unit 14, respectively. Note that the functions implemented by executing the modules are not limited to those and can be modified as appropriate. For example, the functions implemented by executing the determination module P2 may be equal to the functions of the terminal book determination unit 11, and the functions implemented by executing the page management module P3 may be equal to the functions of the terminal page management unit 12 and the book database 21. In this case, the functions implemented by executing the communication module P4 are equal to the functions of the terminal communication unit 13 and the server communication unit 22, and the functions implemented by executing the display restriction module P5 are equal to the functions of the display restriction unit 14 and the post database 23.

The post display program P is provided through a storage medium such as CD-ROM or DVD-ROM or semiconductor memory, for example. Further, the post display program P may be provided as a computer data signal superimposed onto a carrier wave over a communication network.

### <5> Functions and Effects of the Present Invention

According to the reading terminal 1, read pages Pr that have been already displayed in the reading terminal among a plurality of pages are stored firstly as shown in FIG. 4. Then, display restrictions are imposed on posted information C3 to C8 associated with unread pages Pn other than the stored read pages Pr on the reading terminal 1.

It is thereby possible to avoid giving away the content for a user who has not read a part where there is a post containing a spoiler. As a result, it is possible to avoid diminishing a user's interest and prevent a decrease in user-friendliness. Further, because unnecessary information is not displayed, the load on display processing can be reduced. Furthermore, because unnecessary information is not displayed, the waste of a display area can be saved.

Further, the posted information contains the restrictions necessity flag information that can enable the setting to make display restrictions unnecessary. According to the reading terminal 1, posted information to which the setting is applied by the restrictions necessity flag information, among the posted information associated with unread pages, is displayed without display restrictions. Thus, when the setting to make display restrictions unnecessary is applied, display restrictions are not imposed even on the posted information associated with unread pages. For example, posted information that causes no problem when displayed can be displayed by setting the restrictions necessity flag information. Accordingly, a user can see the posted information that causes no problem when displayed.

Further, in the case where a predetermined number or more of inappropriateness information are received by the book server 2, display restrictions are imposed on the posted information corresponding to the inappropriateness information in the reading terminal. Thus, when a predetermined number or more of general users consider the subject posted information as a spoiler and transmit inappropriateness information, for example, the setting is cancelled and display restrictions are imposed.

Further, according to the reading terminal 1, genre information indicating a genre to which an electronic book belongs is stored, and when the stored genre information is a specific genre, processing of imposing display restrictions is not performed. The posted information associated with read pages and unread pages in an electronic book of the genre that has nothing to do with the ending or plot (example: business books, how-to books, recipe books) is thereby displayed without display restrictions. It is thereby possible to let a user view all posted information for an electronic book of a specific genre without any disadvantages to the user.

Further, according to the reading terminal 1, the posted information C3 and C4 associated with pages between the last page P1 of the read pages Pr and the last page Pm of the read pages in reading of a predetermined number of times before in the reading terminal 1, among the stored read pages, are displayed with an increased priority of display as shown in FIG. 6. The posted information C3 and C4 associated with pages that have been read by a user between the last page P1 of the read pages Pr and the last page Pm of the read pages in reading of a predetermined number of times before in the reading terminal 1 can be thereby seen by the user. Because display is restricted in the unread state, it is highly possible that the user has not read the posted information posted in association with the page just read. By the above control, the user can easily see the posted information posted in association with the pages having been read.

Further, according to the reading terminal 1, the posted information C4 associated with the pages Ps between the read page Pa displayed again at the start of the previous reading in the reading terminal 1 and the read page Pb displayed again at the last of the reading is displayed with an increased priority of display as shown in FIG. 7. The read page Pa displayed again at the start of the previous reading in the reading terminal 1 and the read page Pb displayed again at the last of the reading are displayed again even through they are read pages. Therefore, it is considered that the user's interest in those pages is strong. In this case, the posted information associated with the pages in which the user is likely to have a strong interest can be seen by the user.

Further, according to the reading terminal 1, the posted information associated with the read pages that have been displayed a predetermined number of times or more, among the read pages, is displayed with an increased priority of display. Therefore, the posted information associated with the pages in which the user is likely to be interested because they are the read pages having been displayed a predetermined number of times or more can be seen by the user.

Further, according to the reading terminal 1, when it is determined that purchase processing is not done for an electronic book, control of imposing display restrictions is not performed for the posted information associated with predetermined specified pages. By specifying the pages for which display restrictions on posted information are not necessary in order to attract a user's interest as specified pages, the posted information associated with the specified pages can be displayed on the reading terminal 1 without display restrictions. It is thereby possible to make a user have an interest in the electronic book for which purchase processing is not done.

Further, according to the reading terminal 1, the total number (or the graph indicating the number) of posted information associated with unread pages among the acquired posted information is displayed. In general, the content of the posted information associated with unread pages is not displayed by the above-described function to avoid a spoiler even when there are many readers and many posts. However, by displaying the number of posts, a user can recognize the number of posted information associated with unread pages, which is the number of readers. Further, by displaying the graph indicating the number of posts as described later, a user can find the positions of pages in which the other readers are interested in. It is thereby possible to enhance user friendliness.

### <6> Alternative Example

An alternative example is described hereinbelow. Although the configuration in which posted information is received after receiving a request for displaying posted information from a user is described in the above-described embodiment, the configuration in which posted information is received at specified timing may be used. In this case, the reading terminal 1 includes a post database that stores downloaded posted information. The post database stores posted information posted for an electronic book purchased by a user. The terminal communication unit 13 downloads the posted information regardless of whether it is the posted information associated with unread pages. In the reading terminal 1, posted information associated with unread pages is specified from the acquired posted information. Then, the display restriction unit 14 controls display to impose display restrictions on the posted information associated with unread pages.

In this configuration, even when the reading terminal 1 is in off-line mode (mode where communication with the book server 2 is not possible) at the time of receiving a request for displaying posted information from a user, it is possible to specify an unread part and display the posted information without giving away the content. Note that, in the case of using the configuration to receive posted information at specified timing, the reading terminal 1 just needs to newly acquire the posted information that has been updated after receiving the posted information last time from the book server 2.

Further, although the configuration in which the reading terminal 1 makes determination as to whether or not to impose display restrictions on posted information is described in the above-described embodiment, the book server 2 may make this determination. In this case, the book server 2 acquires element information indicating unread pages of a corresponding electronic book from the reading terminal 1 and performs the above-described Steps S03 to S10 to thereby set the way of displaying each of the posted information. Then, the book server 2 transmits each posted information and the way of displaying it in association with each other to the reading terminal 1.

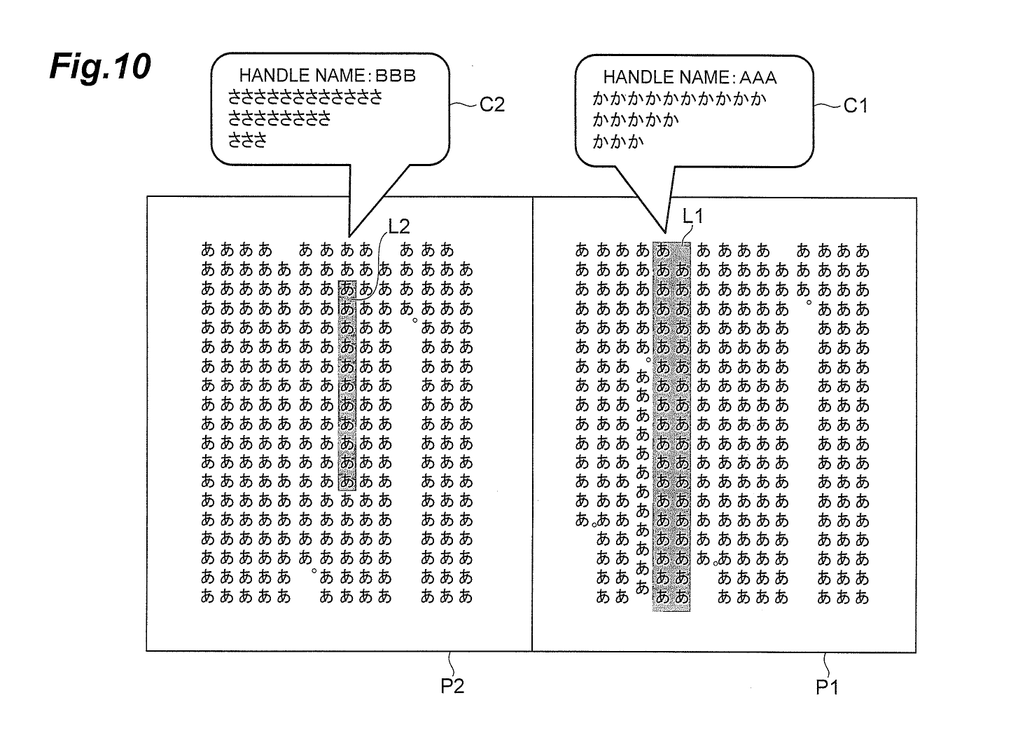

Further, although the configuration in which the posted information C1 and C2 is displayed in the state where a page of an electronic book is not displayed as shown in FIG. 5 is described in the above-described embodiment, a page of an electronic book and posted information can be displayed at the same time. For example, as shown in FIG. 10, at the moment when pages P1 and P2, which are a double-page spread, are displayed, the display time of the pages P1 and P2 is substantially zero, and it is considered that a user has not yet read the pages. Therefore, even when the posted information C1 is posted for a sentence L1 and the posted information C2 is posted for a sentence L2, the posted information C1 and C2 are controlled not to be displayed at the timing immediately after the pages are displayed.

In this case, the terminal page management unit 12 determines that reading of the pages P1 and P2 is done after the lapse of a predetermined set time. The set time is set based on the reading time in the past and the number of pages displayed during the reading time. The terminal page management unit 12 stores a time obtained by dividing the past reading time by the number of pages displayed during the reading time. The time is an average time taken to read one page. In the case where a user reads an electronic book in a double-page spread, the terminal page management unit 12 sets a time that is twice the average time taken to read one page as the set time.

At the timing when the set time has elapsed from when a user operation to turn a page is accepted, the terminal page management unit 12 excludes the page displayed in response to the operation from the unread pages. Thus, at the timing when the set time has elapsed from when the user operation to turn a page is accepted, display restrictions on the posted information associated with the page displayed in response to the page turning operation are cancelled by the display restriction unit 14. In other words, the display restriction unit 14 generates display information for displaying the posted information C1 and C2 associated with the pages P1 and P2 added to the read pages. The posted information C1 and C2 is thereby displayed.

The flow of an automatic display process of posted information as described above is described hereinbelow. First, the step in which the reading terminal 1 accepts a user operation to turn a page is performed. Then, the reading terminal 1 displays the corresponding page of an electronic book. In this step, the reading terminal 1 determines whether there is posted information associated with the corresponding page or not. When there is no posted information associated with the corresponding page, a sequence of the process ends. On the other hand, when there is posted information associated with the corresponding page, the reading terminal 1 specifies posted information for which determination as to whether display restrictions should be imposed or not is to be made.

Then, the reading terminal 1 determines whether the restrictions necessity flag information contained in the posted information for which determination is to be made indicates that restrictions are unnecessary or not. When the flag information does not indicate that restrictions are unnecessary, the reading terminal 1 generates and displays display information for displaying the posted information after the lapse of the set time from display of the corresponding page. On the other hand, when the flag information indicates that restrictions are unnecessary, the reading terminal 1 generates and displays display information for displaying the posted information. Then, a sequence of the process ends.

Note that the set time may be obtained by dividing the start time for reading by the number of times of page turning by a user, or obtained by dividing the display time corresponding to pages to the previous page by the number of times of page turning. Further, in the case where the same electronic book is displayed in the previous day (or the previous time), the set time may be obtained by dividing the display time corresponding to pages displayed before the previous day (or the previous time) by the number of times of page turning. Further, the pages displayed twice or more are generally read faster. Therefore, the pages displayed twice or more may be excluded from the pages displayed in the past in the calculation of the reading speed.

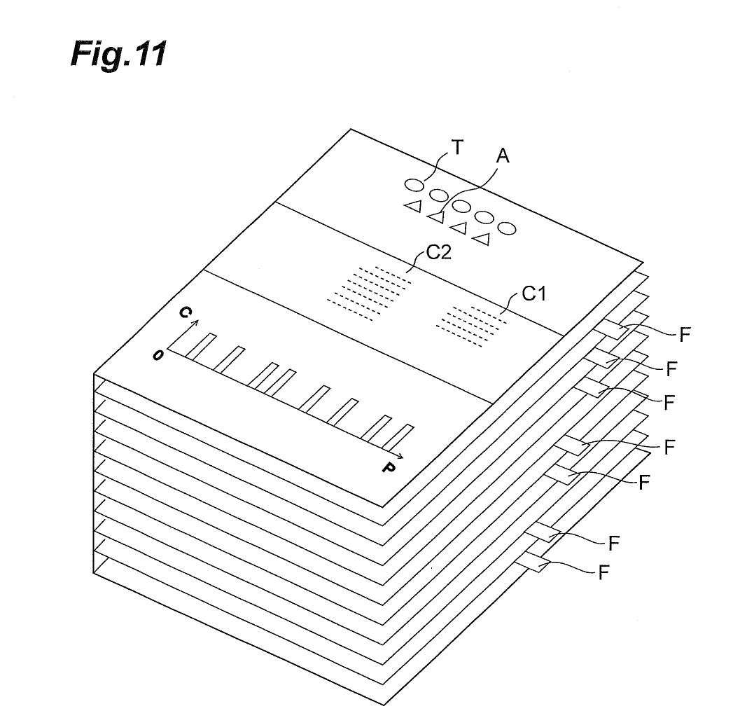

An alternative example of display on the reading terminal 1 is described hereinafter with reference to FIG. 11. FIG. 11 is a schematic diagram illustrating an alternative example of the displayed content on a display of the reading terminal 1. As shown in FIG. 11, a title T, an author name A, and posted information C1 and C2 on which display restrictions are not imposed are displayed on a book representing an electronic book.

At the position of a so-called “wraparound band” of the book representing an electronic book, a graph G indicating the distribution of the number of posted information and pages is displayed. At the “wraparound band” position, the posted information C1 and C2 on which display restrictions are not imposed may be displayed. In the reading terminal 1, when the book representing an electronic book is selected by a user operation, the cover of the book is zoomed in.

Further, each of a plurality of pages corresponding to the posted information on which display restrictions are imposed is labeled with a note F. The note F can be color-coded according to the content of posted information, such as using red for a page having posted information containing a spoiler. Further, a page may be displayed to be more dirty as the number of posted information in the page is larger.

Further, although the case where the reading terminal 1 includes the terminal page management unit 12 (specifying means) and the display restriction unit 14 (restriction means) and serves as a post display system is mainly described in the above embodiment, it is not limited thereto. The book server 2 may include the terminal page management unit 12 (specifying means) and the display restriction unit 14 (restriction means). In this case, the terminal page management unit 12 of the book server 2 stores a read part in association with a user ID and an electronic book. The display restriction unit 14 of the book server 2 generates display information so that posted information associated with unread pages in the reading terminal 1 is displayed in a restricted manner. The display information generated by the display restriction unit 14 is transmitted from the book server 2 to the reading terminal 1. Then, in the reading terminal 1, the posted information associated with unread pages is displayed restricted in a restricted manner.

For example, the display restriction unit 14 of the book server 2 performs control so that the posted information associated with unread pages is not contained in the display restriction. In this case, the posted information associated with unread pages is not transmitted from the book server 2 to the reading terminal 1. Accordingly, in the reading terminal 1, the posted information associated with unread pages is not displayed. It is thereby possible to avoid giving away the content.

### INDUSTRIAL APPLICABILITY

According to the present invention, it is possible to prevent a decrease in user-friendliness to a user who reads an electronic book.

### REFERENCE SIGNS LIST

1 . . . reading terminal, 2 . . . book server, 11 . . . terminal book determination unit, 12 . . . terminal page management unit, 13 . . . terminal communication unit, 14 . . . display restriction unit, 21 . . . book database, 22 . . . server communication unit, 23 . . . post database, 100 . . . information processing system, C1 to C8 . . . posted information, F . . . note, G . . . graph, H1,H2 . . . poster information, NW . . . communication network, P . . . post display program

1-13. (canceled)

14. A post display system for displaying posted information posted for an electronic book, comprising:
a specifying unit configured to specify an unread part of the electronic book not read by a user who reads the posted information; and
a control unit configured to perform control to impose display restrictions on posted information associated with the unread part among posted information associated with any part of the electronic book, wherein
the specifying unit specifies a read part already read by the user, and
the control unit performs control to display posted information associated with a part having been read after reading of a predetermined number of times before, among the read part specified by the specifying unit, with an increased priority of display.

15. A post display system for displaying posted information posted for an electronic book, comprising:
a specifying unit configured to specify an unread part of the electronic book not read by a user who reads the posted information; and
a control unit configured to perform control to impose display restrictions on posted information associated with the unread part among posted information associated with any part of the electronic book, wherein
the specifying unit specifies a read part already read by the user, and
the control unit performs control to display posted information associated with a part between a read part displayed again at start of previous reading and a read part displayed again at last of the reading, among the read part specified by the specifying unit, with an increased priority of display.

16. A post display system for displaying posted information posted for an electronic book, comprising:
a specifying unit configured to specify an unread part of the electronic book not read by a user who reads the posted information; and
a control unit configured to perform control to impose display restrictions on posted information associated with the unread part among posted information associated with any part of the electronic book, wherein
the specifying unit specifies a read part already read by the user, and
the control unit performs control to display posted information associated with a read part having been displayed a predetermined number of times or more, among the read part specified by the specifying unit, with an increased priority of display.

17. A post display system for displaying posted information posted for an electronic book, comprising:
a specifying unit configured to specify an unread part of the electronic book not read by a user who reads the posted information; and
a control unit configured to perform control to impose display restrictions on posted information associated with the unread part among posted information associated with any part of the electronic book, wherein
at timing when a set time has elapsed from when a page turning operation by the user is accepted, the specifying unit excludes a page displayed in response to the page turning operation from the unread part, and
at timing when a set time has elapsed from when a page turning operation by the user is accepted, the control unit performs control to cancel display restrictions on the posted information associated with the page displayed in response to the page turning operation, so that the page and the posted information are displayed simultaneously.

18. The post display system according to claim 17, wherein
the set time is set based on a past reading time and the number of pages displayed during the reading time.

19. A post display method performed by a post display system for displaying posted information posted for an electronic book, comprising:
a specifying step in which the post display system specifies an unread part of the electronic book not read by a user who reads the posted information; and
a control step in which the post display system performs control to impose display restrictions on posted information associated with the unread part among posted information associated with any part of the electronic book, wherein
in the specifying step, the post display system specifies a read part already read by the user, and
in the control step, the post display system performs control to display posted information associated with a part having been read after reading of a predetermined number of times before, among the read part specified in the specifying step, with an increased priority of display.

20. A post display method performed by a post display system for displaying posted information posted for an electronic book, comprising:
a specifying step in which the post display system specifies an unread part of the electronic book not read by a user who reads the posted information; and
a control step in which the post display system performs control to impose display restrictions on posted information associated with the unread part among posted information associated with any part of the electronic book, wherein
in the specifying step, the post display system specifies a read part already read by the user, and
in the control step, the post display system performs control to display posted information associated with a part between a read part displayed again at start of previous reading and a read part displayed again at last of the reading, among the read part specified in the specifying step, with an increased priority of display.

21. A post display method performed by a post display system for displaying posted information posted for an electronic book, comprising:
a specifying step in which the post display system specifies an unread part of the electronic book not read by a user who reads the posted information; and
a control step in which the post display system performs control to impose display restrictions on posted information associated with the unread part among posted information associated with any part of the electronic book, wherein
in the specifying step, the post display system specifies a read part already read by the user, and
in the control step, the post display system performs control to display posted information associated with a read part having been displayed a predetermined number of times or more, among the read part specified in the specifying step, with an increased priority of display.
